(19) United States
(12) Patent Application Publication
(10) Pub. No.: US 2020/0408377 A1
(43) Pub. Date: Dec. 31, 2020

(54) LUMINOUS MODULE OF MOTOR VEHICLE WITH PROVIDED LIGHTING AND/OR SIGNAL FEATURES

(71) Applicant: VALEO VISION SAS, Bobigny (FR)

(72) Inventors: Fabrice EGAL, Bobigny (FR); Julien RIZZI, Bobigny (FR)

(73) Assignee: VALEO VISION SAS, Bobigny (FR)

(21) Appl. No.: 16/763,115

(22) PCT Filed: Nov. 30, 2018
(86) PCT No.: PCT/EP2018/025303

§ 371 Date: Aug. 18, 2020

(30) Foreign Application Priority Data
Nov. 30, 2017 (FR) 1761493

(51) Int. Cl. F21S 41/675; F21S 41/20; F21S 41/255; F21S 41/147; F21S 43/14; F21S 43/20

(52) U.S. Cl. CPC F21S 41/675; F21S 41/285; F21S 41/255; F21Y 2115/10; F21S 43/14; F21S 43/26; F21S 41/147

(57) ABSTRACT

The invention relates to a vehicle's luminous module that includes a light source, a pixelated digital imaging system and an optical input device inserted (along the path of the light rays coming from the source) between the light source and the pixelated digital imaging system in order to transmit some light rays coming from the light source towards the pixelated digital imaging system; the invention also includes a prism comprising first, second and third faces that are configured to: transmit rays of the transmitted portion towards an impact surface between the first and third faces; form reflected rays by reflecting rays returned by the impact surface, by total internal reflection on the first face; and return reflected rays via the second face.

### CROSS-REFERENCE TO RELATED APPLICATIONS

This application is filed under 35 U.S.C. § 371 U.S. National Phase of International Application No. PCT/EP2018/025303 filed Nov. 30, 2018 (published as WO2019105588), which claims priority benefit to French application No. 1761493 filed on Nov. 30, 2017, the disclosures of which are herein incorporated by reference in their entirety.

### TECHNICAL FIELD

The present invention relates to a luminous module for a motor vehicle, and to a lighting and/or signaling device provided with such a module.

### BACKGROUND

A preferred application relates to the automotive industry, for provision on vehicles, in particular for the production of devices capable of emitting light beams, also known as lighting and/or signaling functions, that generally comply with regulations. For example, the invention can enable the production of a pixelated light beam, preferably high-resolution, particularly for signaling and/or contributing to lighting functions at the front of a vehicle. It can be used to display pictograms or variable patterns on a surface for the projection of the light output.

### SUMMARY

The signaling and/or lighting lights of motor vehicles are luminous devices that comprise one or more light sources and an outer lens that closes the light. Put simply, the light source emits light rays to form a light beam that is directed towards the outer lens in order to produce an illuminating surface that transmits light outside the vehicle. These functions must comply with regulations particularly relating to light intensity and viewing angles. The known lighting and signaling modules have to date been suitable for emitting for example:
a low beam, directed downward, sometimes also known as dipped beam and used if other vehicles are present on the carriageway;
a high beam without cut-off, and characterized by maximum illumination along the axis of the vehicle;
a fog beam, characterized by a flat cut-off and a large illumination width;
a dim-dip beam for urban driving, also known as a town light.

Recently, technology has been developed that makes it possible to produce a high-definition pixelated or segmented beam, with a definition of at least 1,000 segments, particularly by means of micro- or nano-electromechanical devices known respectively as MEMS or NEMS. Due to the great flexibility of shape and pattern of the beams that they enable and because their price is tending to decrease, these systems are tending to be installed for increasingly important functions, particularly in headlights at the front of vehicles. FIG. 1 shows an example of the installation of a pixelated digital imaging system in the form of a micromirror array 13 in a module for projecting a beam. A light source 11 generates light rays in the direction of an optical device 12 that makes it possible to generate a beam that will strike a reflective face 14 of a micromirror array 13. Depending on the inclination of the mirrors, which is controlled, the light is either propogated towards the projection device 15, or sent to a dead spot so that it does not contribute to active illumination.

In some cases, this implies significant illumination output and particularly sufficient illumination output in order to comply with the regulatory conditions relating to luminous flux. Achieving significant illumination is however difficult in view of the installation illustrated in FIG. 1. It is easy to understand that enlarging the lens used for the input device 12 or bringing it closer to the micromirror array 13 quickly poses a problem of interference with the lens used as the projection device 15. In the example shown, the beam envelope defined by the rays a1, a2 is on the verge of interfering with the edge of the projection device 15; similarly, the rays b1, b2 propogated by the matrix 13 are transmitted by the device 15 as rays c1, c2 on the verge of interfering with the input device 12. Given this limitation, patent document WO 2017/143371 A1 discloses a headlight for a motor vehicle including a micromirror array and provided with a pair of light-emitting diode light sources each associated with a lens for focusing a light beam on the reflective surface of the micromirror array. This doubling of sources obviously increases the luminous flux leaving the headlight. However, it inevitably increases the cost and footprint.

In other patent documents relating to video projector or motor vehicle light devices, such as GB2418996, CN205388665U and US2016241819, combining two prisms has been proposed, or as in US2013188156, combining a prism with an optical element arranged nearby in order to optimize the luminous flux and reduce the footprint. However, these solutions generate chromatic aberrations that must be corrected via a complex, costly (number of lenses and type of lenses) optical projection system. In addition, in the prism combinations, in order to comply with the total internal reflection conditions, expensive materials must be used to produce the prisms.

The present invention aims to at least partially overcome the drawbacks of the prior art and particularly aims to propose an optical system that is simpler, more compact and more cost-effective.

According to one aspect, the present invention relates to a luminous module for a motor vehicle configured to produce an output beam, comprising a light source comprising at least one light-emitting diode, a pixelated digital imaging system, and an optical input device inserted, along the path of the light rays coming from the light source, between the light source and the pixelated digital imaging system so that it transmits at least a portion, known as the transmitted portion, of the light rays coming from the light source towards an impact surface of the pixelated digital imaging system, characterized in that it includes a prism, comprising a first face, a second face and a third face, and is configured to:
transmit at least one portion of the light rays of the transmitted portion towards the impact surface between the first face and the third face;
form reflected rays by reflecting at least one portion of the light rays propogated by the impact surface, by total internal reflection on the first face;
send or transmit at least one portion of the reflected rays towards a projection zone via the second face.

The light rays are thus diverted on their path from the light source towards the projection device at least partially due to the prism. The function of the prism comprises, upstream of the imaging system, the transmission of light rays coming from the source and, downstream of the imaging system, the total internal reflection making it possible to perform an advantageously large angular modification, so that the rays leaving the prism are propogated in the direction of the projection device. The prism permits large angular variations in beam direction between the beam upstream of the imaging system and the beam downstream thereof.

The position and angle of the optical device situated at the input can thus be adjusted easily, without being hindered by footprint considerations relating to the optical projection device, unlike in the prior art illustrated in FIG. 1. The optical input device of the imaging system can advantageously be brought closer and/or its diameter can be increased (the increase in illumination is directly linked to the increase in the diameter of a lens). In so doing, the luminous efficacy of the beam striking the imaging system is greater, which makes it possible to obtain satisfactory illumination output despite the use of a light-emitting diode source.

According to another aspect, the present invention also relates to a motor vehicle lighting and/or signaling device provided with at least one luminous module. This device can comprise at least one additional module comprising at least one of an additional module configured to produce a basic low beam and an additional module configured to produce a basic high beam.

Advantageously, the pixelated beam can be an effective supplement to another beam, or several other beams. In particular, in a preferred embodiment, the device comprises an additional module configured to produce a basic low beam and an additional module configured to produce a basic high beam and in which the pixelated output beam of the module partially overlaps both the basic high beam and/or the basic low beam. The pixelated beam can thus be used both to perform a function of writing on the ground in the portion overlapping the low beam and to contribute to glare free high beam or dynamic bend light functions for the portion overlapping the high beam.

The present invention also relates to a vehicle provided with at least one module and/or one device according to the present invention.

According to a particularly advantageous embodiment, the module is such that the second face and the third face are on two planes perpendicular to each other.

In addition, it preferably includes an optical device for projecting the output beam at least partially receiving the at least one portion of the propagated rays.

Advantageously, the optical projection device has an optical axis perpendicular to the second face.

Optionally, the optical projection device has an optical axis forming an obtuse angle with a mean direction of the transmitted portion. This option is very useful for limiting the footprint and gives great freedom of lens size for the input optical device.

According to one non-limitative embodiment, the third face is parallel to the impact surface. Advantageously and preferably, the third face includes an anti-reflective coating. This thus avoids phenomena of phantom images that can produce significant reflections propogating from the mirrors on the third face.

In one embodiment, the prism is made from a material the Abbe number of which is greater than or equal to 50. Satisfactory total internal reflection conditions are guaranteed over the entire visible light range.

Advantageously, the prism is made from PMMA or crown glass. These materials are particularly cost-effective.

Optionally, a glass sheet is arranged between the impact surface and the third face.

According to one example, a first face of the glass sheet is situated facing the impact surface and comprises an anti-reflective coating. This thus avoids phenomena of phantom images that can produce significant reflections propogating from the mirrors on the glass sheet.

Advantageously, the anti-reflective coating is configured to reflect less than 4%, preferably less than 2% of the light rays in the visible range.

Preferably, the mean direction of the transmitted portion forms an angle of between −20° and +20° with a normal to the third face.

Preferably, the distance separating the impact surface and the third face is less than or equal to 2 mm, and preferably less than or equal to 1 mm.

In one embodiment, the pixelated digital imaging system comprises a micromirror array.

Optionally, the output beam is configured to project at least one pictogram pattern.

In one preferred embodiment, the module is configured to project a light beam in front of a motor vehicle.

### BRIEF DESCRIPTION OF THE DRAWINGS

Further features and advantages of the present invention will be more clearly understood on reading the description of examples and with reference to the drawings, in which:

FIG. 1 shows a diagrammatic representation of a projection of a pixelated beam according to the prior art;

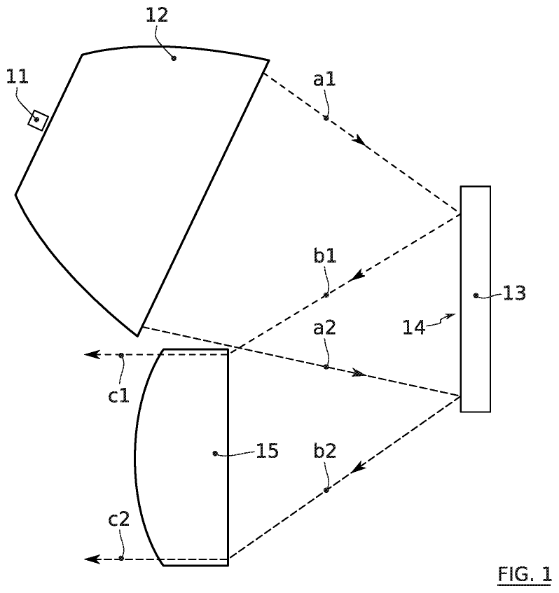

FIG. 2 shows an embodiment of the invention.

### DETAILED DESCRIPTION

Unless otherwise specified, the technical features described in detail for a given embodiment can be combined with technical features described in the context of other embodiments described by way of non-limitative example.

In the features disclosed below, the terms relating to the vertical, horizontal and transverse directions, or equivalents thereof, are given to be relative to the position in which the lighting module is intended to be mounted in a vehicle. The terms “vertical” and “horizontal” are used in the present description to denote directions in an orientation perpendicular to the horizontal plane for the term “vertical”, and in an orientation parallel to the horizontal plane for the term “horizontal”. They should be considered in operating conditions of the device in a vehicle. The use of these words does not mean that slight variations around the vertical and horizontal directions are excluded from the invention. For example, an inclination in relation to these directions of the order of + or −10° is considered herein as a minor variation around the two preferred directions.

The device of the invention incorporates at least one module making it possible to generate a pixelated beam, but also preferably enables the projection of at least one other beam, by means of at least one other module. The device of the invention can therefore be complex and combine several modules that can also optionally share components.

In the context of the invention, low beam is given to mean a beam used in the presence of oncoming vehicles and/or vehicles in front and/or other elements (people, obstacles, etc.) on or near the carriageway. This beam has a downward mean direction. It can optionally be characterized by an absence of light above a plane inclined by 1% downward on the side of the traffic in the other direction, and another plane inclined by 15 degrees relative to the previous plane on the side of the traffic in the same direction, these two planes defining a cut-off in accordance with European regulations. The aim of this downward upper cut-off is to avoid dazzling other users present on the scene of the road extending in front of the vehicle or on the shoulders of the road. The low beam, which previously came from a single headlight, has evolved, and the low beam function can be coupled with other lighting features that are still considered as low beam functions in the present invention.

This particularly includes the following functions:

AFS (Advanced Front Lighting System) which particularly offers other types of beam. It particularly relates to the function known as BL (Bending Light), which can be broken down into a function known as DBL (Dynamic Bending Light) and a function known as FBL (Fixed Bending Light);

Town Light. This function widens a low beam while slightly reducing the range thereof;

Motorway Light, which performs the motorway function. This function increases the range of a low beam while concentrating the luminous flux of the low beam along the optical axis of the projection device in question;

Overhead Light. This function modifies a typical low beam so that gantry signs situated above the road are lit satisfactorily by means of the low beam;

AWL (Adverse Weather Light).

The basic high beam has the function of lighting the scene in front of the vehicle over a wide area, but also over a considerable distance, typically approximately 200 meters. This light beam, due to its lighting function, is situated mainly above the horizon line. It can have a slightly upward optical lighting axis, for example.

The device can also be used to form other lighting functions via or outside those described above.

As stated previously, one aspect of the invention relates to a module that makes it possible to generate a pixelated output beam, that is, processed by a pixelated digital imaging system offering great flexibility, through the control of the imaging system, in terms of beam configurations actually projected. The terms “pixelated digital imaging system” and “pixelated ray imaging system” or equivalents thereof are defined as a system emitting a light beam, said light beam being made up of a plurality of light sub-beams, it being possible to control each light sub-beam independently of the other light sub-beams. These systems can for example be micromirror arrays 23 as shown, liquid crystal devices, or Digital Light Processing (DLP) technology. The micromirror arrays are also known as Digital Micromirror Devices (DMD).

Each independently controllable sub-beam forms a pixelated ray. The micromirror arrays are controlled by control electronics. Each micromirror preferably has two operating positions. A position known as the active position corresponds to an orientation of the micromirrors that enables the reflection of an incident light beam towards an output refracting surface. A position known as the passive position corresponds to an orientation of the micromirrors that enables the reflection of an incident light beam towards an absorbing surface, that is, towards a different direction than that of the output refracting surface. Generally, this type of imaging system is implemented in micro-electromechanical systems known as MEMS, which also includes in the present application nano-systems known as NEMS.

In a manner known per se, a light source 21 is used to illuminate an impact surface 24 of the pixelated imaging system, for example the reflective face of the micromirrors of a micromirror array 23, and the rays processed by the pixelated imaging system are sent in order to be projected, generally by means of an output optical element such as a headlight outer lens or a projector lens. Generally, the present invention can use light-emitting diode, commonly known as LED, light sources. These can optionally be organic LEDs. In particular, these LEDs can be provided with at least one chip capable of emitting light with an intensity that is advantageously adjustable depending on the lighting and/or signaling function to be performed. In addition, the term light source is given herein to mean at least one individual source such as an LED capable of producing a flux resulting in the generation of at least one light beam at the output of the module of the invention. In one advantageous embodiment, the output face of the source has a rectangular cross-section, which is typical for LED chips. Non-limitatively, the light source 21 is configured to produce a luminous flux greater than 3,000 lm and for example of the order of 4,000 lm.

The benefit of pixelated beams in the automotive field and the numerous functionalities that they make possible are fully understood. However, the incorporation thereof into vehicles concomitantly with systems for projecting other beams is as yet largely unexplored and requires a significant amount of space.

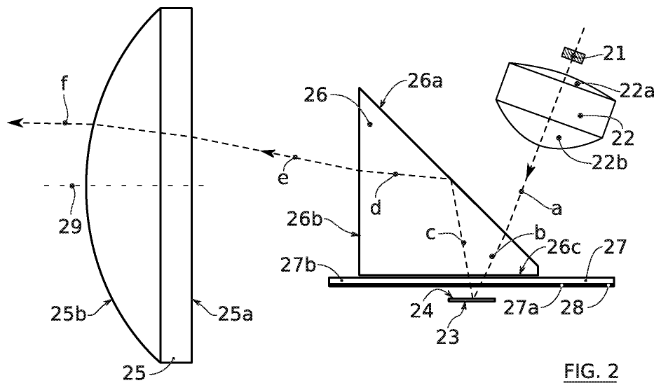

FIG. 2 shows an embodiment of the present invention that enables a relative positioning of the light source and the optical input device that is improved over the prior art.

Travelling upstream to downstream along the path of the light rays, the presence of a light source 21 will be noted, which can be of the type described previously. Preferably, the light source 21 is configured to emit in a half space from a rectangular emissive area. At least one portion of the rays emitted by the source 21 is optically processed by an optical device 22. This device can comprise one or more lenses the complexity of which can vary.

In FIG. 2, the optical device 22 takes the form of a lens having an input face 22a that makes it possible to admit the light rays coming from the source 21 and an output face 22b projecting them in the direction of the rest of the module. At the output of the optical device 17, at least one portion with reference sign “a” known as the transmitted portion of the processed rays is suitable for striking the surface of the pixelated digital imaging system, here a micromirror array 23. However, according to the invention, the light rays first enter through a prism 26, by means of a first face 26a thereof.

Preferably, the angle formed between the first face 26a and the third face 26c is between 40 and 50°, preferably between 44 and 46°, more preferably 45°, to within manufacturing tolerances. This avoids the generation of curvature of field aberrations in the rays reflected by the impact surface 24 towards the inner side of the first face 26a and therefore reduces the cost of the projection system as it does not require elements for correcting these aberrations.

In one configuration of the module dedicated to a writing on the ground function, the first face 26a preferably forms an acute angle with the mean direction of the transmitted portion “a” of the light rays coming from the source 21. More preferably, the mean direction and the normal to the first face 26a form an angle of between −20° and +20°. The quantity of flux retransmitted is thus promoted.

In one configuration of the module including a glare free high beam function, the third face 26c preferably forms an acute angle with the mean direction of the transmitted portion “a” of the light rays coming from the source 21. More preferably, the mean direction and the normal to the third face 26c form an angle of between −20° and +20°. The generation of stray rays on reflection on the impact surface 24 is thus greatly reduced and the emission of a high-contrast pixelated beam is promoted, which is desirable for a glare free function.

Generally, it is desirable to use a transparent material advantageously having a high Abbe number, preferably greater than or equal to 50, for the prism 26. This can be crown glass or polymethyl methacrylate (PMMA).

In order to optimize the pixelated module for use both for writing on the ground functions and glare free high beam functions, preference will be given to a prism material with an Abbe number greater than or equal to 50, an angle of ideally 45° between the first face 26a and the third face 26c and an illumination of the prism by the source 21 such that the mean direction and the normal to the third face 26c form an angle of between −20° and +20°, ideally aligned with the normal.

The light rays entering the prism 26, with reference sign “a” in FIG. 2, are directed towards a third face 26c of the prism 26 facing which is situated the imaging system, which in the example shown is a micromirror matrix 23. Advantageously, the impact surface 24 (corresponding to the exposed surface of the micromirrors) is parallel to the third face 26c, the latter being preferably flat. Advantageously, the impact surface 24 is protected by a glass sheet 27 a first face 27a of which is situated facing the impact surface 24. A second face 27b of the glass sheet 27 is situated facing the third face 26c, in contact therewith or otherwise. Advantageously, the distance separating the impact surface 24 and the third face 26c is limited and can for example be less than 2 mm or even less than 1 mm, and preferably 0.5 mm. The presence of the glass sheet 27 can be used to govern this separation without any risk of damaging the impact surface 24.

In the embodiment illustrated, the elimination or at least the limitation is sought of the unwanted effects that could be produced by a reflection on the third face 26c of the prism 26 or the first face 27a of the glass sheet of the rays that have reached the impact surface 24 and been reflected. To this end, it is advantageous to provide at least the third face 26c of the prism 26, and advantageously the glass sheet 27, with an anti-reflective coating 28 that can be of standard design and particularly configured to produce a reflection of 4% at most, or even of 2% at most in the visible spectrum. The anti-reflective coating is preferably selected with a maximum reflection of 1% in the visible spectrum. In the context of use with a requirement for high contrast, preference will be given to a maximum reflection of 0.2%, more preferably 0.1%, in the visible spectrum.

Preferably, the impact surface 24 defined by the micromirror assembly is rectangular. It extends preferably in a plane perpendicular to the plane of the second face 26b of the prism 26 and/or parallel to an optical axis of the projection device 25.

Depending on the orientation of the mirrors, the rays are reflected either so that they contribute to the projected beam or so that they are inactive. In this way, the configuration of the pixelated beam can be controlled at will. In the embodiment shown, the active rays “c” are directed so that they enter the prism 26 again through the third face 26c. The path of the rays is configured so that the active rays “c” reach the first face 26a again. However, this time, the angle of the rays relative to the first face 26a is such that this produces a total internal reflection in the prism 26 so that reflected rays “d” are formed that are directed towards the second face 26b of the prism 26.

The output rays “e” are directed towards a projection device 25, which typically is or comprises a projector lens. In the embodiment illustrated, this is a plano-convex lens, the input face 25a of which is flat and the output face 25b of which is convex. The reference sign “1” represents an example of a projected ray.

Advantageously, the prism 26 is configured, in terms of angle and selection of materials, so that all of the light rays coming from the input device 22 are transmitted to the micromirror array 23 and so that all of the light rays reflected by the latter are reflected by the first face 26a. It will be noted that the area of the first face 26a through which the rays “a” enter the prism 26 and the area of the first face 26a through which the rays “c” reach the first face 26a again in order to be reflected, can overlap.

The invention is not limited to the embodiments described but applies to any embodiment within the spirit of the invention.

### LIST OF REFERENCES

11. Light source
12. Optical device
13. Micromirror array
14. Reflective face
15. Optical projection device
21. Light source
22. Optical input device
22a. Input face
22b. Output face
23. Micromirror array
24. Impact surface
25. Optical projection device
25a. Input face
25b. Output face
26. Prism
26a. First face
26b. Second face
26c. Third face
27. Glass sheet
27a. First face
27b. Second face
28. Anti-reflective coating
29. Optical axis

What is claimed is:

1. A luminous module of a motor vehicle configured to produce an output beam, comprising a light source comprising at least one light-emitting diode, a pixelated digital imaging system, and an optical input device inserted, along the path of the light rays coming from the light source, between the light source and the pixelated digital imaging system so that it transmits at least a portion, known as the transmitted portion, of the light rays coming from the light source towards an impact surface of the pixelated digital imaging system, characterized in that it includes a prism, comprising a first face, a second face and a third face, and configured to:
transmit between the first face and the third face at least one portion of the light rays of the transmitted portion towards the impact surface;
form reflected rays by reflecting at least one portion of the light rays propagated by the impact surface, by total internal reflection on the first face;
send at least one portion of the reflected rays towards a projection zone via the second face.

2. The luminous module as claimed in claim 1, where the second face and the third face are held by two planes perpendicular to each other.

3. The luminous module as claimed in claim 2, also including an optical projection device for projecting the output beam that at least partially receives the at least one portion of the light rays, which are propagated.

4. The luminous module as claimed in claim 3, in which the optical projection device has an optical axis perpendicular to the second face.

5. The luminous module as claimed in claim 4, where the optical projection device has an optical axis forming an obtuse angle with a mean direction of the transmitted portion.

6. The luminous module as claimed in claim 1, in which the third face is parallel to the impact surface.

7. The luminous module as claimed in claim 1, in which the third face of the prism situated facing the impact surface comprises an anti-reflective coating.

8. The luminous module as claimed in claim 7, in which the anti-reflective coating is configured to reflect at 4% or less than 4% of the light rays in the visible range.

9. The luminous module as claimed in claim 1, in which the prism is made from a material the Abbe number of which is greater than or equal to 50.

10. The luminous module as claimed in claim 1, in which the prism is made from PMMA or “crown glass.”

11. The luminous module as claimed in claim 1, including a glass sheet arranged between the impact surface and the third face.

12. The luminous module as claimed in claim 5, in which the mean direction of the transmitted portion forms an angle about and of between −20° and +20° with a normal to the third face.

13. The luminous module as claimed in claim 1, in which the pixelated digital imaging system comprises a micromirror array.

14. The luminous module as claimed in claim 1, in which the output beam is configured to project at least one pictogram pattern.

15. The luminous module as claimed in claim 1, configured to project a light beam in front of a motor vehicle.

16. A vehicle lighting or signaling device that provides at least one module as claimed in claim 12.

17. The luminous module claimed in 7, in which the anti-reflective coating is configured preferably to reflect at 2% or less than 2% of the light rays in the visible range.
